(19) United States
(12) Patent Application Publication
(10) Pub. No.: US 2015/0244768 A1
(43) Pub. Date: Aug. 27, 2015

(54) CREATING AND MANAGING READ ORDER INSTRUCTION FILES

(71) Applicant: INTERNATIONAL BUSINESS MACHINES CORPORATION, Armonk, NY (US)

(72) Inventors: Gregory Jensen Boss, Saginaw, MI (US); Andrew R. Jones, Round Rock, TX (US); Charles Steven Lingafelt, Durham, NC (US); Kevin C. McConnell, Austin, TX (US); John Elbert Moore, JR., Indianapolis, IN (US)

(73) Assignee: INTERNATIONAL BUSINESS MACHINES CORPORATION, Armonk, NY (US)

(21) Appl. No.: 14/188,242

(22) Filed: Feb. 24, 2014

(51) Int. Cl. H04L 29/08

(52) U.S. Cl. CPC H04L 67/06; H04L 67/10

(57) ABSTRACT

A method includes a computing device receiving read source content from at least one content provider; the computing device creating a read order file for the received read source content in accordance with at least one selected criteria; the computing device packaging the read order file into a computer readable schema file; and delivering the computer readable schema file to at least one user device.

### BACKGROUND

The present invention relates to managing web source information, and more specifically, to creating and managing read order instruction files for the web source information.

### SUMMARY

According to one aspect of the present invention, A method includes a computing device receiving read source content from at least one content provider; the computing device creating a read order file for the received read source content in accordance with at least one selected criteria; the computing device packaging the read order file into a computer readable schema file; and delivering the computer readable schema file to at least one user device.

According to another aspect of the present invention, a system includes one or more processors, one or more computer-readable memories and one or more computer-readable, tangible storage devices; a receiving module operatively coupled to at least one of the one or more storage devices for execution by at least one of the one or more processors via at least one of the one or more memories, configured to receive read source content from at least one content provider; a creating module operatively coupled to at least one of the one or more storage devices for execution by at least one of the one or more processors via at least one of the one or more memories, configured to create a read order file for the received read source content in accordance with at least one selected criteria; a packaging module operatively coupled to at least one of the one or more storage devices for execution by at least one of the one or more processors via at least one of the one or more memories, configured to package the read order file into a computer readable schema file; and a delivering module operatively coupled to at least one of the one or more storage devices for execution by at least one of the one or more processors via at least one of the one or more memories, configured to deliver the computer readable schema file to at least one user device.

According to yet another aspect of the present invention, a computer program product includes one or more computer-readable, tangible storage medium; program instructions, stored on at least one of the one or more storage medium, to receive read source content from at least one content provider; program instructions, stored on at least one of the one or more storage medium, to create a read order file for the received read source content in accordance with at least one selected criteria; program instructions, stored on at least one of the one or more storage medium, to package the read order file into a computer readable schema file; and program instructions, stored on at least one of the one or more storage medium, to deliver the computer readable schema file to at least one user device.

### BRIEF DESCRIPTION OF THE SEVERAL VIEWS OF THE DRAWINGS

FIG. 1 shows a flowchart according to an embodiment of the present invention.

FIG. 2 shows a flowchart according to another embodiment of the present invention.

FIG. 3 shows a flowchart according to still another embodiment of the present invention.

FIG. 4 shows a flowchart according to yet another embodiment of the present invention.

FIGS. 5A-5C show exemplary implementations according to embodiments of the present invention.

FIG. 6 shows another exemplary implementation according to an embodiment of the present invention.

FIG. 7 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

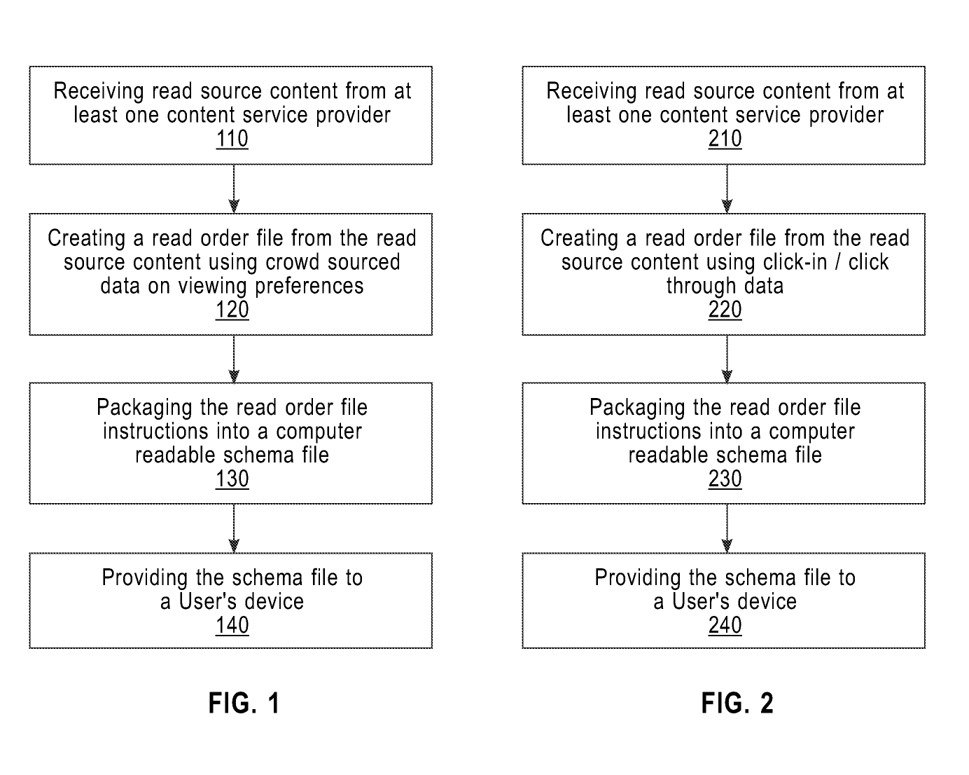

Now referring to FIG. 1, an embodiment of the present invention uses web pages and sites that are typically composed of content that is either statically or dynamically rendered and then read by end users. In its simplest forms, this is typically a static page of hypertext markup language (HTML) that is rendered and displayed to a user via a browser. The markup language defines the content and how the content should be displayed to the user (e.g. font, size of font, font attributes (e.g. bold), where to display on the page, etc). Audio readers of web pages are often used to read the content of a web page to those that are visually impaired. This is typically done in a left-to-right/top-to-bottom manner for the entirety of the page. In the American culture, for some types of web sites, in a frame element that starts about ¼ way down the page and ⅕ of the way from left to right. In other cultures, the typical placement of the primary of interest frame may be located in a different layout. The embodiment includes a process for receiving the web read source content from at least one content service provider (110). The process continues by creating a read order file from the read source content using crowd sourced data on viewing preferences (120).

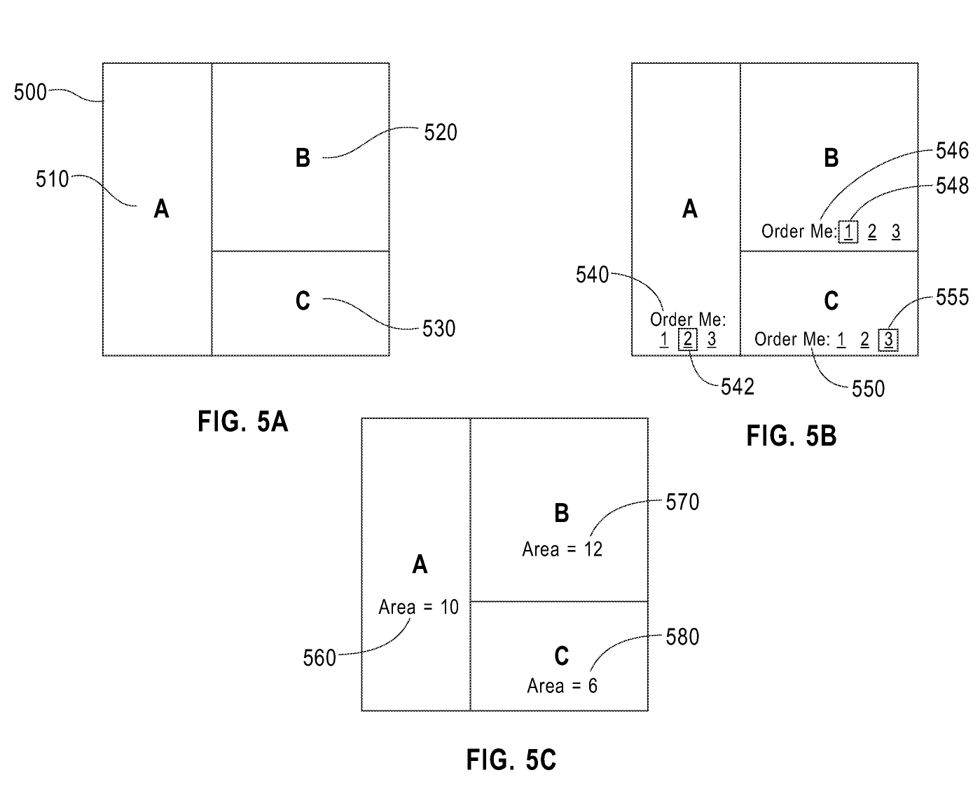

Crowd sourcing methods (e.g. like page rankings) gathers input from other viewers on the preferred order for viewing the specific web page. In an exemplary implementation, a web page 500 has 3 parts, as shown in FIG. 5A, (Section A, 510; Section B, 520; and Section C, 530). The bottom of each section includes (A, B, C) may have user visual or audio descriptors (540, 546 and 550, respectively) and selectable links (542, 548 and 555, respectively) as shown in FIG. 5B. The links allow all users to specify the reading order of the 3 sections. The information gathered from users of the web page that specify the order is gathered and analyzed (e.g. simple sorting of results or more complex analysis using additional data like size of frame, where data is pulled from if content is dynamic, etc). Based upon the analysis results, information for the read order file can be obtained. In this exemplary implementation, the information obtained via crowd sourcing may indicated the order of the web page 500 to be sections B, A, and C. In the above exemplary implementation, sections A, B, and C may point to specific named frames in the HTML, style sheet elements, or other content that defines the ranked part of the web page 500.

Still referring to FIG. 1, the process continues by packaging the read order instructions into a computer readable schema file (130). The read order file may be conveyed to the user either as single file or multiple files or may be conveyed along with other files or content. Three exemplary implementation of schemas are mentioned hereafter. In these schemas, the read order of web page elements is an ordered list.
Schema Format 1: Specify read order by element size:
The size may be quantified or be a percentage.
For example: Read the elements in this order: Elements with frames between 200 and 400 pixels, elements with frames larger than 400 pixels, elements with frames between 100 and 200 pixels, elements smaller than 200 pixels
For example: Read element in this order: Elements larger than 50% of screen, elements between 25 and 50% of screen, elements smaller than 25% of screen.
Schema Format 2: Specify the read order by screen location: The location may be quantified or percentage
For example: Read the elements in this order: Elements between (x=0, y=0) and (x=200, y=400), elements between (x=400, y=100) and (x=edge of screen, y=edge of screen)
For example: Read the elements in this order: Elements whose upper left corner are found between (x=0, y=0) and (x=200, y=400) . . . etc. (e.g. if the cell or frame's top left corner is found in that bounding box, then . . . )
For example: Read element in this order: Elements between (x=0% y=0%) and (x=25%, y=30%), elements between (x=50%, y=75%) and (x=edge of screen, y=edge of screen)
Schema Format 3: Specify the read order by weighting: Each type of element or location of element is assigned a weighting, to be assessed against each web page by the reader component
For example the following weights are assigned by size of frame.
Largest frame=10
smallest frame=1
frames between 5% and 25% of area=3
frames between 25% and 50% of area=6
For example the following weights are assigned by element
type
text=3
banners=5
tables=2
The weights may be modified to reflect other attributes
such as
if domain=“xyz”, then banner weight=banner weight*2
if domain=“abc” then largest frame weight=largest frame weight+10

It should be noted that the number of schema formats to describe the read order information is unlimited, that within each schema format, the specific details of the format can also be unlimited and one can categorize the specific type of page as a category, i.e., a sports page. If the page is from a sports site using the crowd sourcing process, for example, see FIG. 1, the information can be described as follows, using the schema format 1 above:
Web Page Type=sports.
Page Element order=Areas>10, Areas between 10 and 7,
Areas less than 7.
   Where the rendering of the page elements are done in the BAC order. More specifically, FIG. 5C shows that element B (570) has an area of 12, element A (560) has an area of 10, and element C (580) has an area of 6.

It should be noted that the read order file creator can specific a preference for which schema to apply, if multiple schema is applicable. This preference can be expressed by an priority ordered list of schema or by a dynamic rule which can select schema based on other information, e.g., if schema “A” exists, then use schema “A”, if schema “A does not exist, then use the user's priority ordered list to determine the schema to apply.

Still referring to FIG. 1, once the computer readable schema file is created, it is delivered to a user's device for further processing and used in playback (140). An exemplary implementation according to an embodiment of the present invention will be further described hereafter.

Referring to FIG. 2, another embodiment of the present invention uses another process for creating a computer readable read order file. The embodiment includes a process for receiving the web read source content from at least one content service provider (210). The process continues by creating a read order file from the read source content using click-in/click through data (220). This method utilizes data from viewers of a page's click-in (clicking on an hyper link the the HTML that jumps to another spot on the same page) and click-through (hyperlink to another HTML page) data to determine what parts of a web page are being viewed most. By gathering this data, a preference can be determined for reading order. For instance, if part A 510 (FIG. 5A) has 5 internal links that have been clicked 7000 in total, part B 520 has 2 links clicked 300 times, and part C 530 has 5 internal links that have been clicked only 1000 times, the read order generated may be: A,C,B. In addition to these types of links, links to videos and content or applications could be counted and used in the generation of the read order.

Still referring to FIG. 2, the process continues by packaging the read order instructions into a computer readable schema file (230). The read order file may be conveyed to the user either as single file or multiple files or may be conveyed along with other files or content. Once the computer readable schema file is created, it is delivered to a user's device for further processing and playback (240). An exemplary implementation according to an embodiment of the present invention will be further described hereafter.

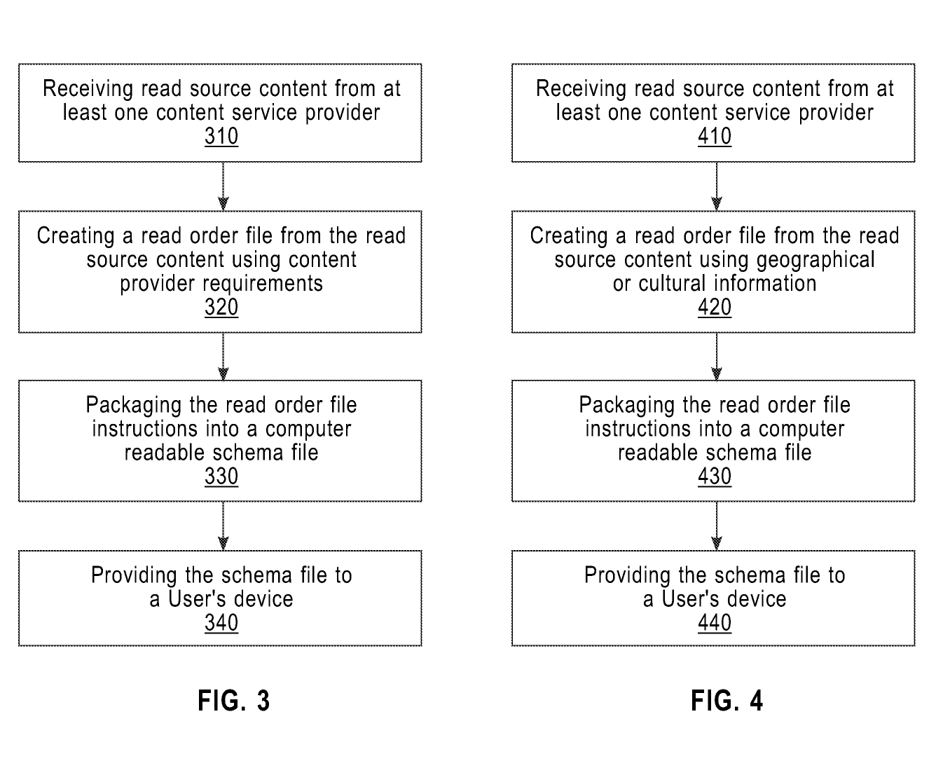

Referring to FIG. 3, yet another embodiment of the present invention uses another process for creating a computer readable read order file. The embodiment includes a process for receiving the web read source content from at least one content service provider (310). The process continues by creating a read order file from the read source content provider requirements (320). The owner, publisher or delegate may specify via information contained in the web page or in information reference by the page the order that the page elements should be read. These requirements may be based upon advertisement priorities or legal requirements. The process continues by packaging the read order file into a computer readable schema file (330). Once the computer readable schema file is created, it is delivered to a user's device for further processing and playback (340). An exemplary implementation according to an embodiment of the present invention will be further described hereafter.

Referring to FIG. 4, still another embodiment of the present invention uses another process for creating a computer readable read order file. The embodiment includes a process for receiving the web read source content from at least one content service provider (410). The process continues by creating a read order file from the read source content using geographical or cultural information (420). A web page may have dynamic language translation enabled, and the end-user language preference can be gathered. This language data can be utilized in conjunction one or more of the above methods (or other methods) to determine language or country specific preferences, for example: An English page elements may be ordered from left to right, top to bottom, while a Hebrew page may be right to left, top to bottom. Other examples of this type of read order could be the use of the end user's IP addresses which can be associated with specific domains and countries/geographies. The process continues by packaging the read order file into a computer readable schema file (430). Once the computer readable schema file is created, it is delivered to a user's device for further processing and playback (440). An exemplary implementation according to an embodiment of the present invention will be further described hereafter.

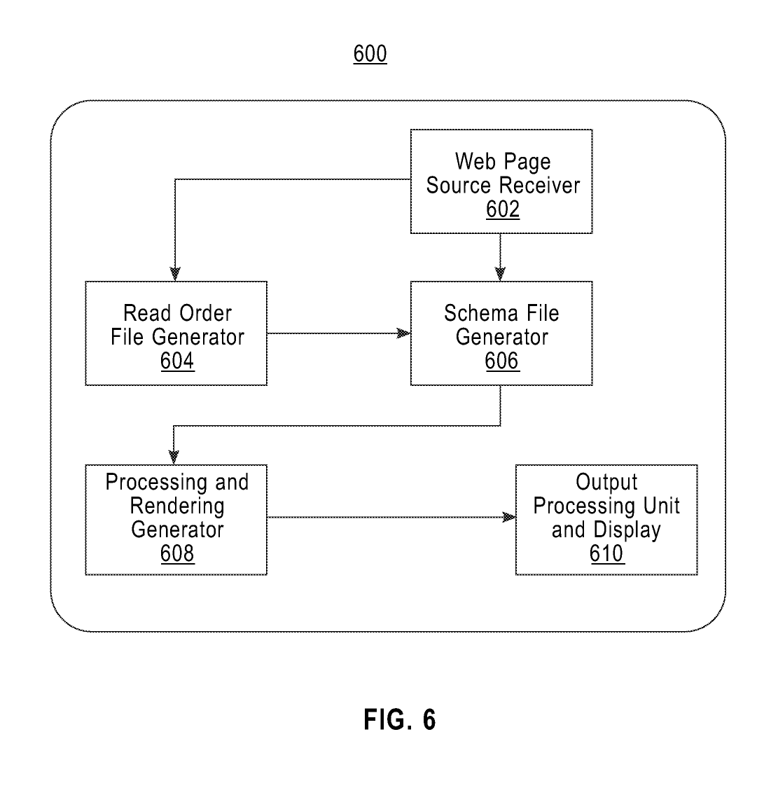

Referring to FIG. 6 an exemplary implementation according to an embodiment of the present invention is depicted. A user's device 600 receives web pages from various sources 602. A read order generator 604 generates computer readable read order file based on several possible processes and requirements. A schema file generator 606 receives both the web source content and the read order file and outputs a computer readable schema file which is used by a processing/rendering generator 608 in combination with an output processing and display unit 610 within the user's device. While this exemplary implementation uses an embodiment within the user's device, it is possible that a third party may provide the computer readable schema file to many user devices.

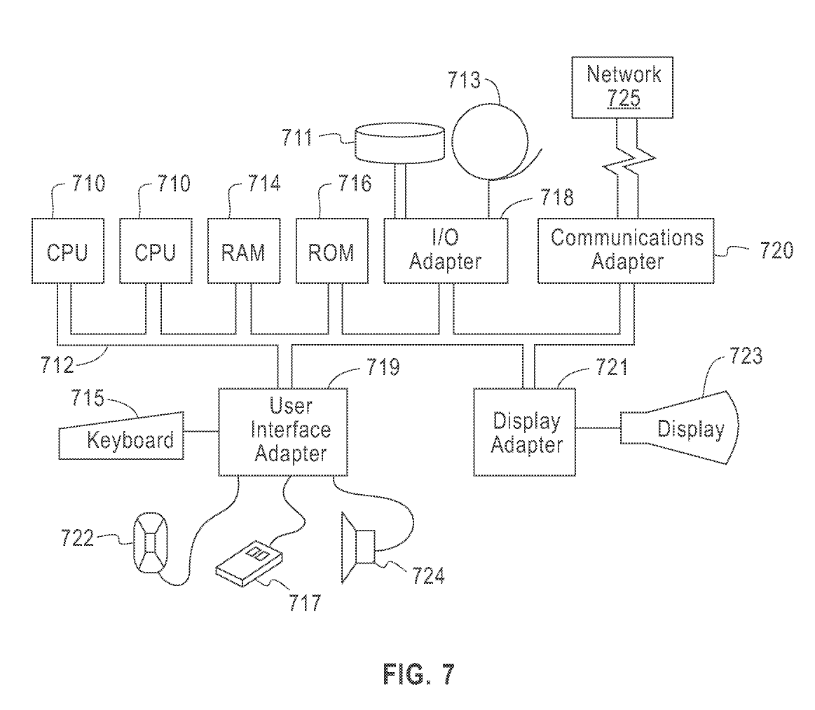

Referring now to FIG. 7, this schematic drawing illustrates a hardware configuration of an information handling/computer system in accordance with the embodiments of the invention. The system comprises at least one processor or central processing unit (CPU) 710. The CPUs 710 are interconnected via system bus 712 to various devices such as a random access memory (RAM) 714, read-only memory (ROM) 716, and an input/output (I/O) adapter 718. The I/O adapter 718 can connect to peripheral devices, such as disk units 711 and tape drives 713, or other program storage devices that are readable by the system. The system can read the inventive instructions on the program storage devices and follow these instructions to execute the methodology of the embodiments of the invention. The system further includes a user interface adapter 719 that connects a keyboard 715, mouse 717, speaker 724, microphone 722, and/or other user interface devices such as a touch screen device (not shown) to the bus 712 to gather user input. Additionally, a communication adapter 720 connects the bus 712 to a data processing network 725, and a display adapter 721 connects the bus 712 to a display device 723 which may be embodied as an output device such as a monitor, printer, or transmitter, for example.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
a computing device receiving read source content from at least one content provider;
the computing device creating a read order file for the received read source content in accordance with at least one selected criteria;
the computing device packaging the read order file into a computer readable schema file; and
delivering the computer readable schema file to at least one user device.

2. The method according to claim 1, wherein the at least one selected criteria is based upon crowd sourced data for viewing preferences.

3. The method according to claim 1, wherein the at least one selected criteria is based upon clicked-in data.

4. The method according to claim 1, wherein the at least one selected criteria is based upon clicked-through data.

5. The method according to claim 1, wherein the at least one selected criteria is based upon the geography location of the at least one user device.

6. The method according to claim 1, wherein the at least one selected criteria is based upon the at least one content provider requirements.

7. The method according to claim 2, wherein the computer readable schema file is based upon element sizes of the at least one selected criteria.

8. A system comprising:
one or more processors, one or more computer-readable memories and one or more computer-readable, tangible storage devices;
a receiving module operatively coupled to at least one of the one or more storage devices for execution by at least one of the one or more processors via at least one of the one or more memories, configured to receive read source content from at least one content provider;
a creating module operatively coupled to at least one of the one or more storage devices for execution by at least one of the one or more processors via at least one of the one or more memories, configured to create a read order file for the received read source content in accordance with at least one selected criteria;
a packaging module operatively coupled to at least one of the one or more storage devices for execution by at least one of the one or more processors via at least one of the one or more memories, configured to package the read order file into a computer readable schema file; and
a delivering module operatively coupled to at least one of the one or more storage devices for execution by at least one of the one or more processors via at least one of the one or more memories, configured to deliver the computer readable schema file to at least one user device.

9. The system according to claim 8, wherein the at least one selected criteria is based upon crowd sourced data for viewing preferences.

10. The system according to claim 8, wherein the at least one selected criteria is based upon clicked-in data.

11. The system according to claim 8, wherein the at least one selected criteria is based upon clicked-through data.

12. The system according to claim 8, wherein the at least one selected criteria is based upon the geography location of the at least one user device.

13. The system according to claim 8, wherein the at least one selected criteria is based upon the at least one content provider requirements.

14. The system according to claim 9, wherein the computer readable schema file is based upon element sizes of the at least one selected criteria.

15. A computer program product comprising:
one or more computer-readable, tangible storage medium;
program instructions, stored on at least one of the one or more storage medium, to receive read source content from at least one content provider;
program instructions, stored on at least one of the one or more storage medium, to create a read order file for the received read source content in accordance with at least one selected criteria;
program instructions, stored on at least one of the one or more storage medium, to package the read order file into a computer readable schema file; and
program instructions, stored on at least one of the one or more storage medium, to deliver the computer readable schema file to at least one user device.

16. The computer program product according to claim 15, wherein the at least one selected criteria is based upon crowd sourced data for viewing preferences.

17. The computer program product according to claim 15, wherein the at least one selected criteria is based upon clicked-in data.

18. The computer program product according to claim 15, wherein the at least one selected criteria is based upon clicked-through data.

19. The computer program product according to claim 15, wherein the at least one selected criteria is based upon the geography location of the at least one user device.

20. The computer program product according to claim 16, wherein the computer readable schema file is based upon element sizes of the at least one selected criteria.
